(19) United States
(12) Patent Application Publication
(10) Pub. No.: US 2017/0227103 A1
(43) Pub. Date: Aug. 10, 2017

(54) TORQUE VECTORING DIFFERENTIAL

(71) Applicant: Eaton Corporation, Cleveland, OH (US)

(72) Inventors: Douglas Hughes, Commerce Township, MI (US); Payam Naghshtabrizi, Royal Oak, MI (US); James K. Spring, Brighton, MI (US); Bradley Wright, Dayton, OH (US)

(73) Assignee: Eaton Corporation, Cleveland, OH (US)

(21) Appl. No.: 15/497,328

(22) Filed: Apr. 26, 2017

Related U.S. Application Data
(63) Continuation of application No. PCT/US2015/057948, filed on Oct. 29, 2015.
(60) Provisional application No. 62/069,913, filed on Oct. 29, 2014.
(60) Provisional application No. 62/119,484, filed on Feb. 23, 2015.

(51) Int. Cl. F16H 48/30; B60K 23/04

(52) U.S. Cl. CPC F16H 48/30; B60K 23/04; F16H 48/20

(57) ABSTRACT

A torque vectoring differential constructed in accordance to the present disclosure includes a differential carrier rotatable about an axis. A pinion carrier can have at least one pinion gear mounted for rotation on at least a portion of the pinion carrier. First and second side gears can be meshed for engagement with at least one pinion gear. The first side gear can be engaged for rotation with a first axle shaft. The second side gear can be engaged for rotation with a second axle shaft. A first clutch can be operable to selectively lock the differential carrier and the pinion carrier with respect to one another for rotation about the axis. A second clutch can be operable to selectively lock the differential carrier to the first side gear. A third clutch can be operable to selectively lock the differential carrier to the second side gear.

### CROSS-REFERENCE TO RELATED APPLICATIONS

This application is a continuation of International Application No. PCT/US2015/057948 filed Oct. 29, 2015, which claims the benefit of U.S. Patent Application No. 62/069,913 filed on Oct. 29, 2014 and U.S. Patent Application No. 62/119,484 filed on Feb. 23, 2015. The disclosures of the above applications are incorporated herein by reference.

### FIELD

The present disclosure relates generally to differential assemblies and, more particularly, to a differential configured to apply torque vectoring among the wheels of a vehicle.

### BACKGROUND

Differentials are provided on vehicles, for example, to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning, to the drive wheel that is not spinning.

Torque vectoring involves creating a difference in braking or driving forces at each wheel to generate a yaw moment (torque). The purpose of torque vectoring is controlling a yaw rate or a vehicle yaw response. Torque vectoring can be accomplished by increasing the drive torque to the outside wheels and creating an effective braking torque at the inside wheels. The drive torque is cumulative to the normal drive torque applied to control vehicle speed. The ability to tune yaw behavior through torque vectoring can diminish the compromise between turning response and vehicle stability.

The background description provided herein is for the purpose of generally presenting the context of the disclosure. Work of the presently named Inventors, to the extent it is described in this background section, as well as aspects of the description that may not otherwise qualify as prior art at the time of filing, are neither expressly nor impliedly admitted as prior art against the present disclosure.

### SUMMARY

A torque vectoring differential constructed in accordance to the present disclosure includes a differential carrier rotatable about an axis. A pinion carrier can have at least one pinion gear mounted for rotation on at least a portion of the pinion carrier. First and second side gears can be meshed for engagement with at least one pinion gear. The first side gear can be engaged for rotation with a first axle shaft. The second side gear can be engaged for rotation with a second axle shaft. A first clutch can be operable to selectively lock the differential carrier and the pinion carrier with respect to one another for rotation about the axis. A second clutch can be operable to selectively modulate the differential carrier to the first side gear. A third clutch can be operable to selectively modulate the differential carrier to the second side gear.

According to other features the torque vectoring differential is selectively and alternatively operable in an open mode, a torque vectoring mode, a limited slip mode and a locking mode. In the open mode, the first clutch is locked and the second and third clutches are disengaged. In the torque vectoring mode, the first clutch is disengaged and the first and second clutches are modulated between fully locked and fully open positions. In the limited slip mode, the first clutch is engaged, the second clutch is disengaged and the third clutch is modulated between fully locked and fully open positions. Either of second or third clutches can be modulated or both can be modulated. In the locking mode, the first clutch is locked and at least two of the second and third clutches are locked.

According to other features, the first clutch is positioned within the differential carrier and is radially outward of the pinion carrier with respect to the axis. The pinion carrier further includes a case defining a cavity and a shaft extending across the cavity. One or more pinion gears are mounted on the shaft. The first clutch can engage the case. The differential carrier can further comprise a primary housing and a secondary housing. The primary housing can define first and second chambers. The pinion carrier and the first clutch can be positioned in the first chamber. The secondary housing can define a third chamber. The primary and secondary housings can be releasably coupled together.

In other features, a first end cap can be releasably engageable with the primary housing to selectively close the second chamber. A second end cap can be releasably engageable with the secondary housing to selectively close the third chamber. The differential carrier can further include a central hub positioned between the primary housing and the secondary housing along the axis. A fluid pathway can extend through the central hub. The fluid pathway can be operable to direct fluid to the first clutch. The central hub can include a series of lugs arranged therearound. The series of lugs can be received in complementary openings defined around a ring that acts against the first clutch. The lugs can be received in complementary grooves defined around an inner diameter of the primary housing. A center clutch spring can normally bias the center piston to compress the first clutch. The center clutch spring can comprise at least one Belleville washer.

According to additional features, the differential carrier further includes first and second chambers. The first clutch is positioned in the first chamber. The second clutch is positioned in the second chamber. The differential carrier further includes a primary housing and a secondary housing. The primary housing includes a wall that separates the first and second chambers. The pinion carrier and the first clutch are positioned in the first chamber. The second clutch is positioned in the second chamber. A secondary housing defines a third chamber. The primary and secondary housings are releasably coupled together. The third clutch is positioned in the third chamber. At least one of the first, second and third clutches is a dog clutch. The torque vectoring differential is lubricated by automatic transmission fluid shared with a transmission and configured to enter the differential carrier through a journal bearing. A helical groove pump can pump the automatic transmission fluid through the torque vectoring differential.

A torque vectoring differential that outputs torque to a first and a second drive axle can include a planetary gear set, a differential assembly and a torque vectoring assembly. The planetary gear set can provide a final drive gear ratio from a transmission. The torque vectoring assembly can include a first gear set that provides an output from the torque vectoring assembly to the first drive axle. A secondary gear set can be independently interfaced with a first clutch. The second gear set can selectively provide torque in a driving direction to the first drive axle. A third gear set can be independently interfaced with the second clutch. The third gear set can selectively provide torque in a retarding direction to the first drive axle.

According to other features, the first, second and third gear sets can all provide unique gear ratios. When the second gear set is selected, the first drive axle can rotate around 20% faster than the second drive axle. When the third gear set is selected, the first drive axle rotates around 20% slower than the second drive axle. In the forward driving direction, torque is alternatively applied in the driving direction as driving torque and in the coasting direction as retarding torque.

### BRIEF DESCRIPTION OF THE DRAWINGS

The present disclosure will become more fully understood from the detailed description and the accompanying drawings, wherein:

FIG. 1 is a perspective view of a torque vectoring differential constructed in accordance to one example of the present disclosure;

FIG. 2 is a cross-section of the torque vectoring differential of FIG. 1 and shown in an exemplary front wheel drive housing;

FIG. 3 is a perspective view of a torque vectoring differential constructed in accordance to another example of the present disclosure;

FIG. 4 is a cross-section of the torque vectoring differential of FIG. 3;

FIG. 5 is a cross-section of the torque vectoring differential of FIG. 4 and shown with a torque path in an open mode;

FIG. 6 is a cross-section of the torque vectoring differential of FIG. 4 and shown with a torque path in a torque vectoring mode;

FIG. 7A is a schematic depiction of the torque vectoring differential of FIG. 4. shown in the open mode;

FIG. 7B is a schematic depiction of the torque vectoring differential of FIG. 4 shown in the torque vectoring mode;

FIG. 7C is a schematic depiction of the torque vectoring differential of FIG. 4 shown in the limited slip mode;

FIG. 7D is a schematic depiction of the torque vectoring differential of FIG. 4 shown in a locking mode;

FIG. 8 is a cross-section of the torque vectoring differential of FIG. 4 illustrating a primary lubrication flow path;

FIG. 9 is a perspective view of the center clutch spring and clutch pack; and

FIG. 10 is an exploded view of the central hub and segmented lug.

### DETAILED DESCRIPTION

Examples of the present disclosure can provide torque vectoring capability improved over currently available systems having more than one clutch. Current systems have characteristics that are undesirable if applied to a vehicle with only one drive axle, such as failure modes associated with the loss of a clutch and the need to modulate clutch torques in order to allow differential action when the vehicle is turning. Examples of the present disclosure can mitigate these issues by retaining the differential gear set assembly and adding a clutch which is normally engaged and which remains engaged when actuator power is lost, such as a spring-applied clutch. This additional clutch selectively couples a pinion gear carrier to a differential carrier and can be disengaged during torque vectoring event to allow independent modulation of wheel torques through clutches associated with each wheel. The clutches associated with particular wheels can normally be disengaged and remain disengaged when actuator power is lost. Examples of the present disclosure can provide torque vectoring among the wheels driven by the differential assembly while still retaining all of the functional features of an open differential. In addition, the examples of the present disclosure can provide controlled limited slip as well as full differential lock up to the torque capacity of the clutches. The torque vectoring differentials disclosed herein are configured for use in a front wheel drive vehicle. It is contemplated that the same may be used in rear wheel drive configurations as well.

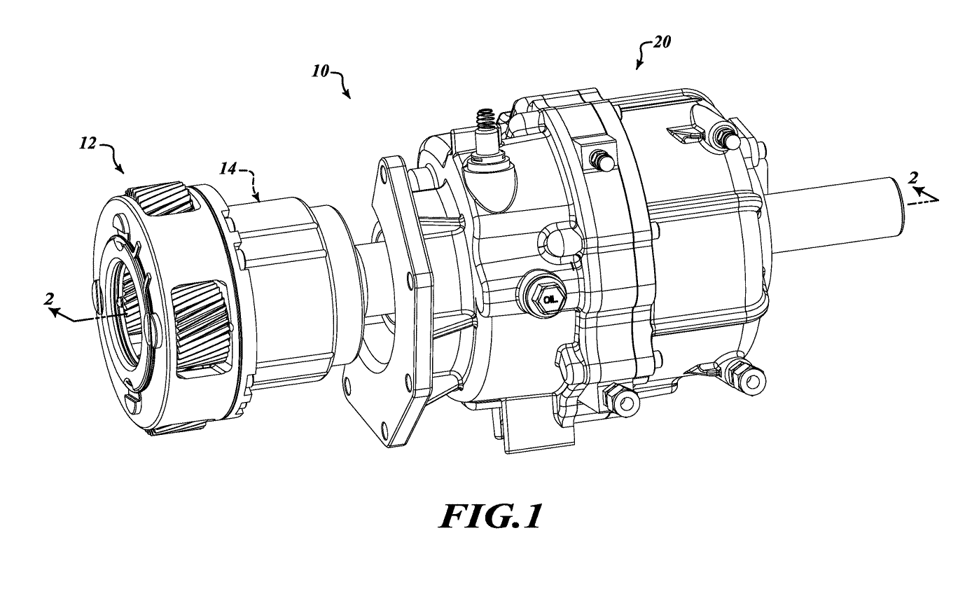

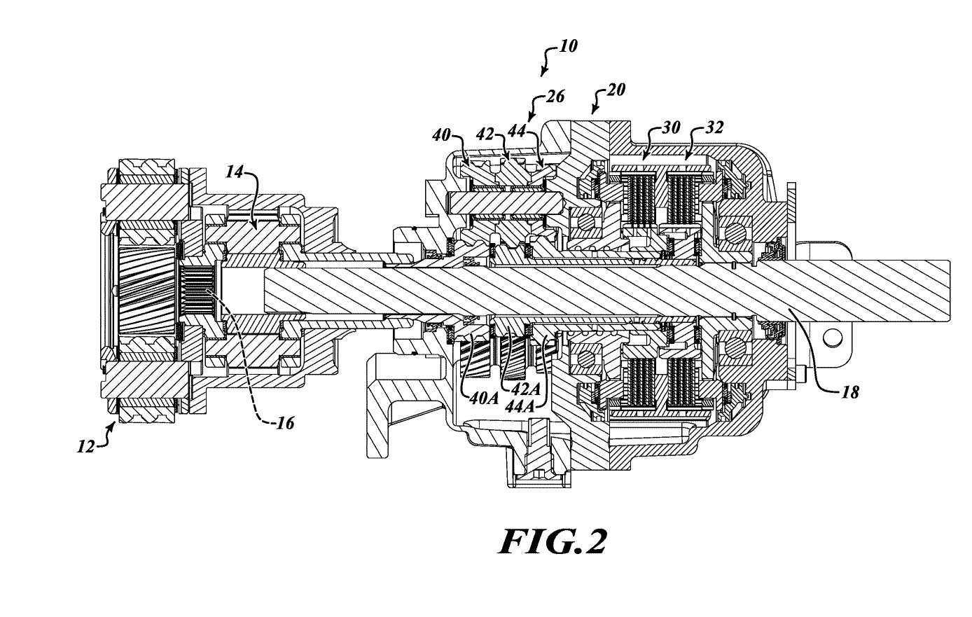

Referring now to FIGS. 1 and 2, a torque vectoring differential constructed in accordance to one example of the present disclosure is shown and generally identified at reference numeral 10. The torque vectoring differential 10 can generally include a planetary gear set 12, a differential assembly 14, and a torque vectoring assembly 20.

The planetary gear set 12 can provide a final drive gear ratio from a transmission of the vehicle. The differential assembly 14 shown is a planar differential however other configurations, such as a bevel gear differential are contemplated. The differential assembly 14 is a conventional differential that can split torque evenly between a first axle shaft 16 (removed from FIG. 2 for clarity but represented by phantom lead line) and a second axle shaft 18.

The torque vectoring assembly 20 can generally include a gear set assembly collectively identified at reference 26, a first clutch 30, and a second clutch 32. The gear set assembly 26 further includes a first gear set 40, a second gear set 42 and a third gear set 44. The first, second and third gear sets 40, 42 and 44 provide unique gear ratio outputs. The first gear set 40 provides an output from the torque vectoring assembly 20 to the first axle shaft 16. The second gear set 42 is independently interfaced with the second clutch 32. The third gear set 44 is independently interfaced with the first clutch 30. In the particular example, the ratios of the second and third gear sets 42 and 44 are configured such that the total output to the first axle shaft 16 is around 20% faster than the speed of the second axle shaft 18 or around 20% slower than the speed of the second axle shaft 18. In this regard, in the forward driving direction, torque can be applied in the driving direction (driving torque) or in the coasting direction (retarding torque). As used herein, “around 20%” can include percentages between 15% and 25%. It will be appreciated that the gear sets 42 and 44 may be configured to provide other percentages of average axle speed.

The first gear set 40 includes an output gear 40A that communicates an output from the torque vectoring gear train to the first axle shaft 16. The output gear 40A extends through the planar differential assembly 14 and couples to the first axle shaft 16. Explained further, the output gear 40A mechanically interfaces (splines) with the planet carrier of the differential assembly 14 and to the first axle shaft 16. It does not apply load to the differential gears.

The following description relates to a vehicle traveling in the forward direction. The second gear set 42 includes an input gear 42A. The third gear set 44 includes an input gear 44A. When the second gear set 42 is selected, the input gear 42A selectively applies torque in the retarding direction. When the third gear set 44 is selected, the input gear 44A selectively applies torque in the driving direction. The second and third gear sets 42 and 44 are selected by applying the respective clutches 32 and 30. The input to the first and second clutches 30 and 32 is the second axle shaft 18. The output of the clutches 30 and 32 is communicated to the first axle shaft 16 by way of the gear set assembly 26 dependent upon selection of either the driving direction (third gear set 44) or the retarding direction (second gear set 42). The third gear set 44 applies torque in direction that tends to make the first axle shaft 16 turn 20% faster than the second axle shaft 18. The second gear set 42 applies torque in direction that tends to make the first axle shaft 16 turn 20% slower than second axle shaft 18.

The clutches 30 and 32 can be selectively modulated based on operating conditions of the vehicle. In this regard, the clutch 30 can be modulated between various operating states between fully locked and fully opened. Similarly, the clutch 32 can be modulated between various operating states between fully locked and fully opened.

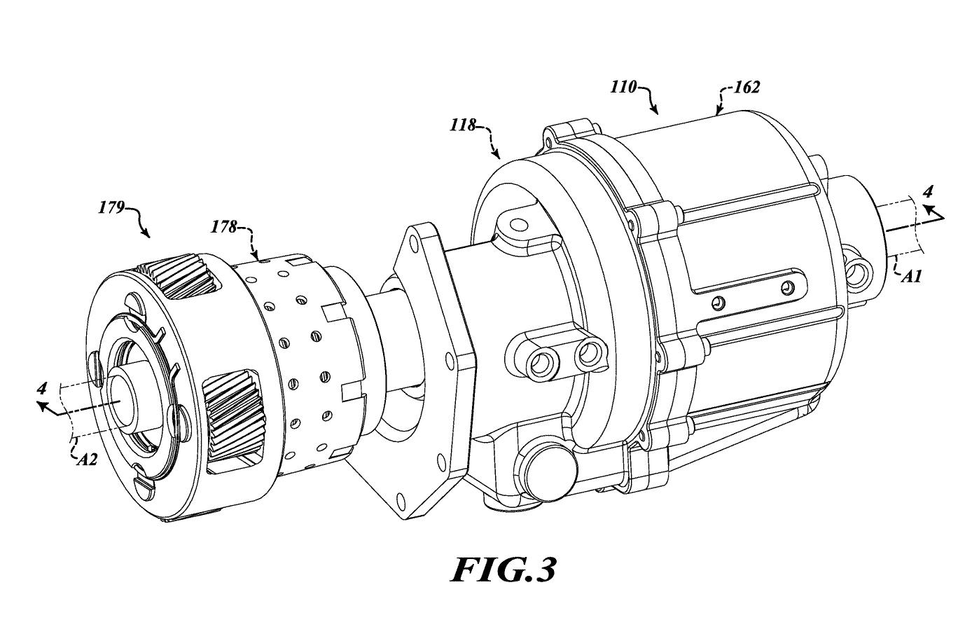

Referring now to FIGS. 3-10, a torque vectoring differential 110 can include a differential carrier 114, a pinion carrier 115, pinion gears 116A and 116B, and a first clutch 118. The differential carrier 114 can be rotatable about an axis 120. The pinion carrier 115 can be positioned at least partially within the differential carrier 114. The pinion gears 116A and 116B can be mounted for rotation on at least a portion of the pinion carrier 115. The first clutch 118 can be operable to selectively lock the differential carrier 114 and the pinion carrier 115 with respect to one another for rotation about the axis 120.

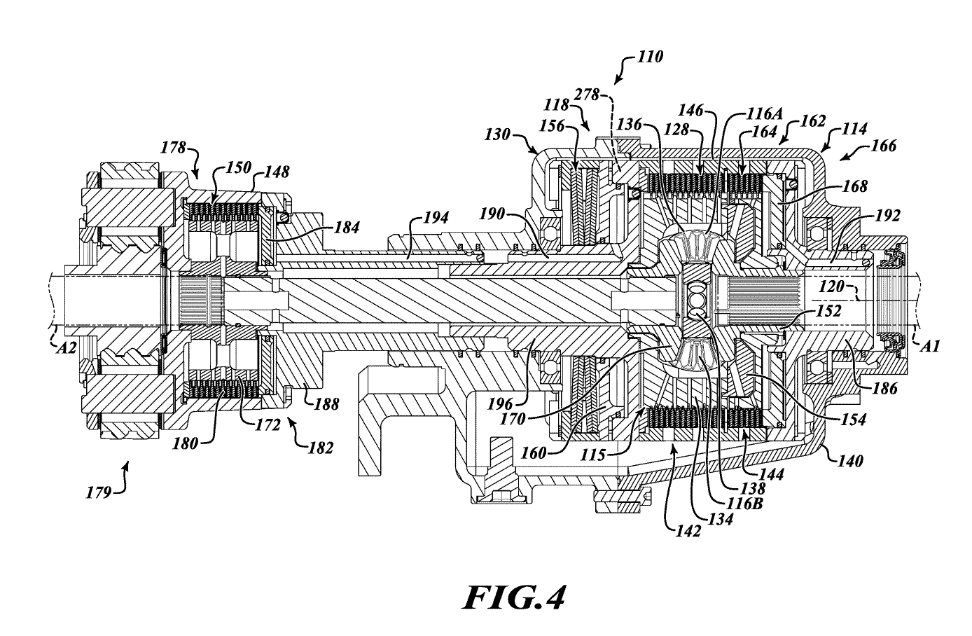

The first clutch 118 can include a clutch pack 128 and an actuator 130. In one configuration, the first clutch 118 can be spring applied and hydraulically released. In other examples, the first clutch 118 can be hydraulically actuated and released. The actuator 130 can include a center clutch spring 156 that normally biases a center piston 160 to compress the clutch pack 128. In one configuration, the center clutch spring 156 can be one or a collection of Belleville washers. Fluid can be directed to a back face of the center piston 160 to urge the center piston 160 away from the clutch pack 128 (or in a direction leftward as viewed in FIG. 4) to decompress the clutch pack 128. When the clutch pack 128 is compressed by the actuator 130, the differential carrier 114 and the pinion carrier 115 can rotate together about the axis 120. The differential carrier 114 can drive the pinion carrier 115 in rotation about the axis 120. When the clutch pack 128 is not compressed by the actuator 130, the differential carrier 114 can rotate relative to the pinion carrier 115. The clutch actuation could be provided in a variety of ways in various examples of the present disclosure, such as hydraulic piston, ball-ramp, and electromechanical.

The pinion carrier 115 can include a case 134 defining a cavity 136. The pinion carrier 115 can also include a shaft 138 extending across the cavity 136. It will be appreciated that a plurality of shafts may be provided corresponding to the number of pinion gears. The pinion gears 116A and 116B can be mounted on a respective shaft 138. The first clutch 118 can be arranged to selectively engage the case 134 of the pinion carrier 115.

The differential carrier 114 can include a primary housing 140 defining first and second chambers 142, 144. The first and second chambers 142, 144 can be at least partially separated by a wall 146. The differential carrier 114 can also include a secondary housing 148 defining a third chamber 150. The primary and secondary housings 140, 148 can be releasably coupled together.

The torque vectoring differential 110 can also include a first side gear 152. The first side gear 152 can be in meshed engagement with the pinion gears 116A and 116B. The first side gear 152 can have a first set of splines that can engage an axle shaft A1 and the axle shaft A1 can be connected to a wheel of a vehicle.

The torque vectoring differential 110 can also include a second clutch 162 operable to selectively lock the differential carrier 114 to the side gear 152. A first coupling ring 154 can be disposed adjacent to the side gear 152. The second clutch 162 can include a clutch pack 164 and an actuator 166. The actuator 166 can include a thrust plate 168. Fluid can be directed to a back face of the thrust plate 168 to urge the thrust plate 168 against the clutch pack 164 (or in a direction leftward as viewed in FIG. 4) and compress the clutch pack 164. When the clutch pack 164 is compressed by the actuator 166, the differential carrier 114 and the side gear 152 can rotate together about the axis 120. The differential carrier 114 and side gear 152 can rotate about the axis 120. When the clutch pack 164 is not compressed by the actuator 166, the differential carrier 144 can rotate relative to the side gear 152. The clutch actuation could be provided in a variety of ways in various examples of the present disclosure, such as hydraulic piston, ball-ramp, and electromechanical.

The torque vectoring differential 110 can also include a second side gear 170 and a second coupling ring 172. The second side gear 170 can be in meshed engagement with the pinion gears 116A and 116b. The second side gear 170 can have a third set of splines that can engage an axle shaft A2 and the axle shaft A2 can be connected to a wheel of a vehicle. The second coupling ring 172 can have a fourth set of splines that can also engage the axle A2 connected to the wheel of the vehicle.

The torque vectoring differential 110 can also include a third clutch 178 operable to selectively lock the differential carrier 114 and the second coupling ring 172. A planetary gear set 179 can provide a final drive gear ratio from a transmission of the vehicle. The third clutch 178 can include a clutch pack 180 and an actuator 182. The actuator 182 can include a thrust plate 184. Fluid can be directed to a back face of the thrust plate 184 to urge the thrust plate 184 (In a direction leftward as viewed in FIG. 4) against the clutch pack 180 and compress the clutch pack 180. When the clutch pack 180 is compressed by the actuator 182, the differential carrier 114 and the second coupling ring 172 can rotate together about the axis 120. The differential carrier 114 can drive the second coupling ring 172 in rotation about the axis 120. When the clutch pack 180 is not compressed by the actuator 182, the differential carrier 114 can rotate relative to the second coupling ring 172. The clutch actuation could be provided in a variety of ways in various examples of the present disclosure, such as hydraulic piston, ball-ramp, and electromechanical.

The first, second and third clutches 118, 162, 178 can be positioned in the differential carrier 114. The first clutch 118 and the pinion carrier 115 can be positioned in the first chamber 142. The second clutch 162 and the first coupling ring 154 can be positioned in the second chamber 144. The third clutch 178 and the second coupling ring 172 can be positioned in the third chamber 150. One or more of the first, second and third clutches 118, 162, 178 can be a dog clutch. In an example of the present disclosure in which hydraulic actuation is applied for the first, second and third clutches 118, 162, 178 it can be possible to design the hydraulic circuit to automatically disengage (i.e., pressurize) the first clutch 118 whenever the second clutch 162 or the third clutch 178 is pressurized in order to simplify the controls.

A first fluid pathway 190 (FIG. 4) can extend through a central hub 196 to direct fluid to act against a back face of the center piston 160 to urge the center piston 160 against the bias of the center clutch spring 156 to decompress the first clutch 118. A second fluid pathway 192 can extend through an end cap 186 to direct fluid to the actuator 166 of the second clutch 162 urging the thrust plate 168 toward the clutch pack 164 compressing the second clutch 162. A third fluid pathway 194 can extend through a clutch housing 188 of the third clutch 178 to direct fluid to the actuator 182 of the third clutch 178 urging the thrust plate 184 toward the clutch pack 180 compressing the third clutch 178.

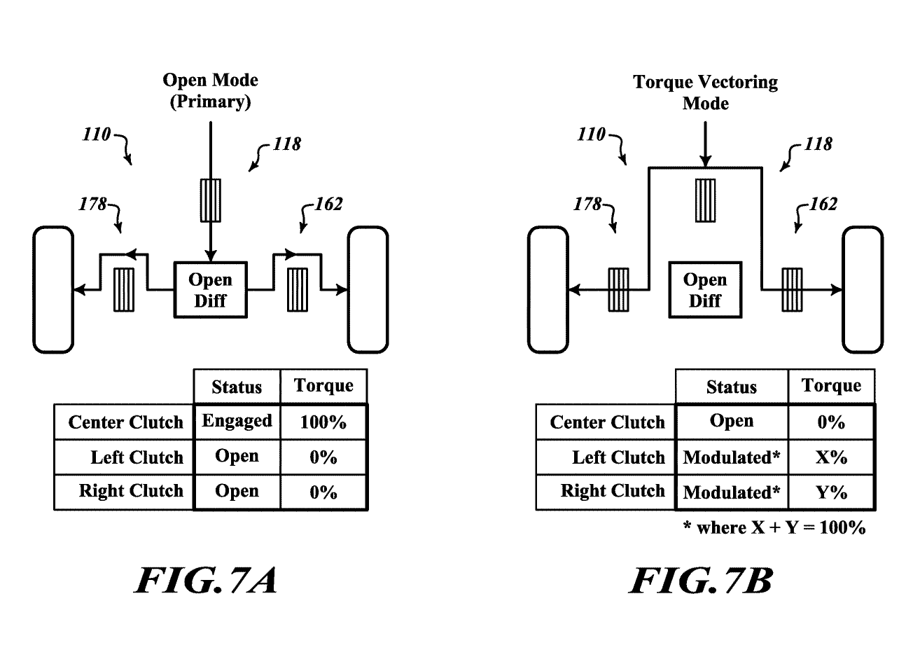

The toque vectoring differential 110 is operable in each of the following drive modes (see also FIGS. 7A-7D), an open mode (FIG. 7A), a torque vectoring mode (FIG. 7B), a limited slip mode (FIG. 7C) and a locked mode (FIG. 7D). In operation, the torque vectoring differential 110 can define a differential assembly operable to direct torque to two or more wheels of a vehicle. The differential assembly 110 can vector torque among the wheels. An open functionality can be attained by the differential assembly 110. The first clutch 118 can be positioned between the differential carrier 114 of the differential assembly 110 and the pinion carrier 115 of the differential assembly 110. The second clutch 162 can be positioned between the first axle A1 extending from the differential assembly 110 and the differential carrier 114. The third clutch 178 can be positioned between the second axle A2 extending from the differential assembly 110 and the differential carrier 114.

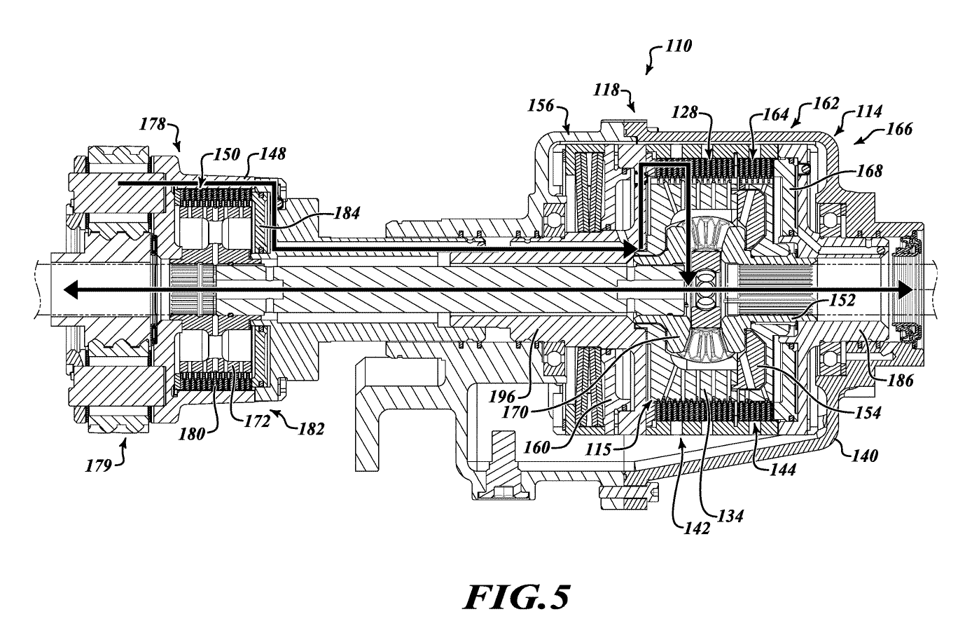

With specific reference to FIGS. 5 and 7A, the differential assembly 110 can operate in the open functionality by engaging the first clutch 118 and disengaging both of the second and third clutches 162, 178. In the open mode, 50% of the total torque can be delivered through the first axle A1 and 50% of the total torque can be delivered through the second axle A2.

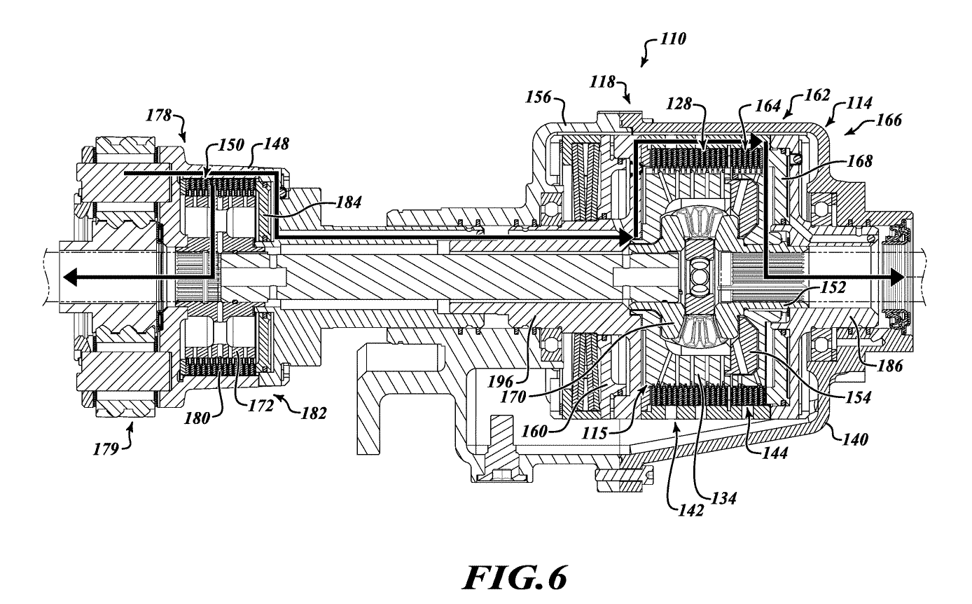

With reference to FIGS. 6 and 7B, the differential assembly 110 can operate in a torque vectoring mode. Torque vectoring can be executed by disengaging the first clutch 118 and modulating both of the second and third clutches 162, 178 to achieve a desired yaw moment. As used herein, the term “modulate” is used to refer to moving a particular clutch to a fully locked state, a fully open state, one or more operating states between fully locked and fully open. For example, the third clutch 178 can be engaged 25% and the second clutch 162 can be engaged 75% allowing 25% of the total torque to be delivered to the second axle A2 and 75% of the total torque to be delivered to the first axle A1. Other ratios are contemplated for delivering torque to the first and second axles A1 and A2 depending on operating conditions. It will be appreciated that the torque vectoring will be based on driving conditions. The second and third clutches 162 and 178 can be engaged to varying degrees for speeding up the outer wheel or speeding down the inner wheel. In another example, the first clutch 118 can be additionally modulated.

FIGS. 7C and 7D are schematic illustrations of the differential assembly 110 operating in a limited slip mode (FIG. 7C) and a locking mode (FIG. 7D). The differential assembly 110 can operate in a limited slip functionality by engaging the first clutch 118, disengaging the second clutch and modulating the third clutch 178. In a locking mode, any two clutches of the first clutch 118, the second clutch 162 and the third clutch 178 can be engaged 100% to provide a locked condition.

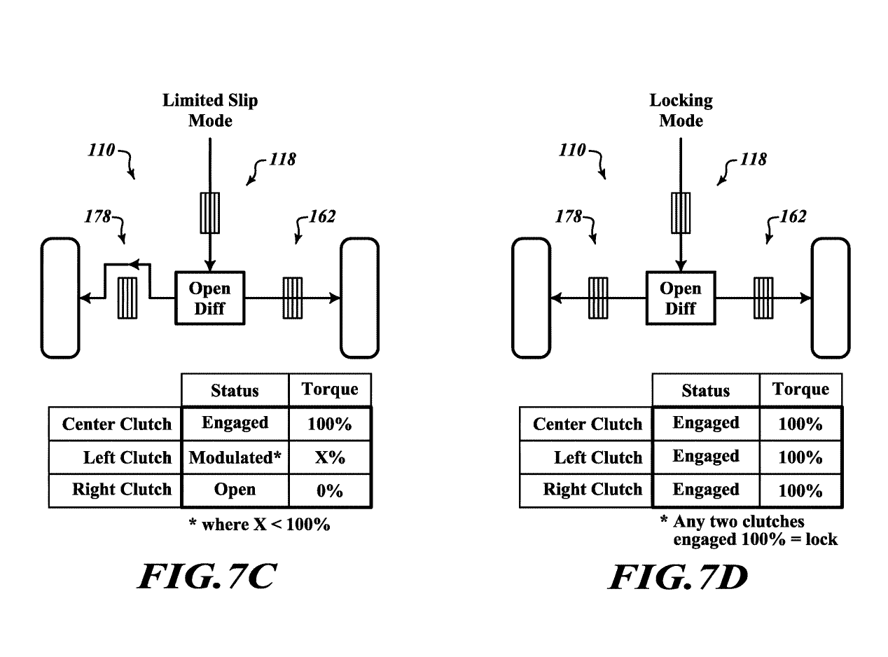

Turning now to FIG. 8, a lubrication flow path, generally identified at reference numeral 220 according to one example of the present disclosure will be described. The lubricant can be automatic transmission fluid (ATF) shared with the automatic transmission of the vehicle. The lubrication flow path 220 can provide a first flow path 220 that enters the differential assembly 110 through a final drive journal bearing 226. Other configurations for introducing ATF into the differential assembly 110 are contemplated. Once the lubricant enters the differential assembly 110, a helical groove pump 230 can direct the lubricant through a passage 232 where the lubricant flows in opposite directions along a second fluid flow path 236. For clarity, the helical groove pump 230 has been shown only in FIG. 8, however it will be appreciated that the helical groove pump 230 may be incorporated in all Figures having the differential assembly 110. In other examples, a helical groove pump may be omitted. From the second fluid flow path 236, the lubricant is directed along a third fluid flow path 240 where the lubricant is distributed through the first, second and third clutches 118, 162 and 178. After lubricating the first, second and third clutches 118, 162 and 178, the lubricant can flow along a fourth fluid path 244 toward the ATF sump where the lubricant can be recirculated. A balance tube connected to the transmission may be provided along a fifth fluid path 248 to assist in recirculation of the lubricant.

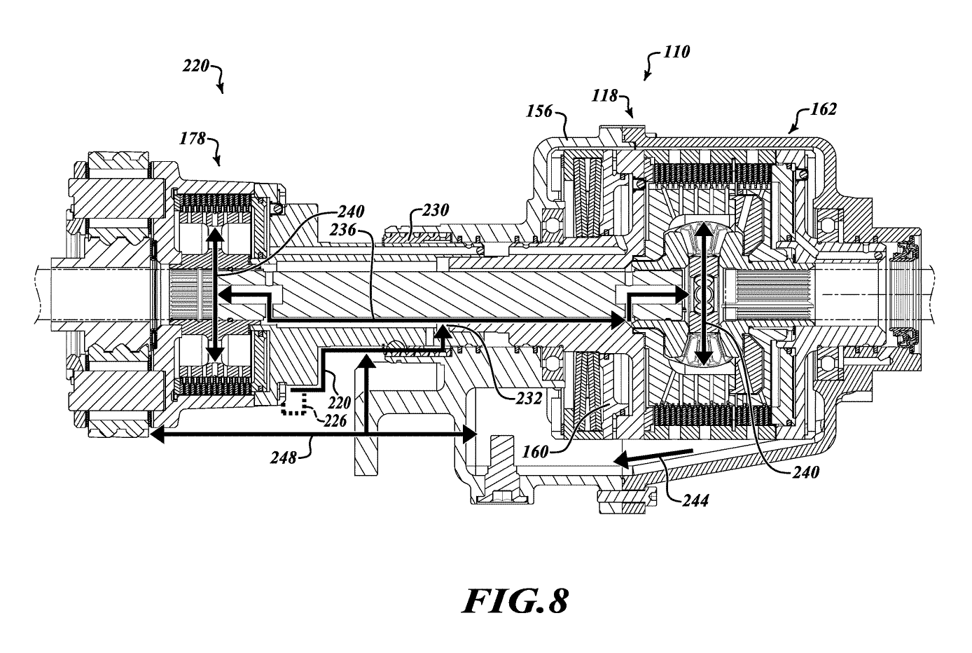

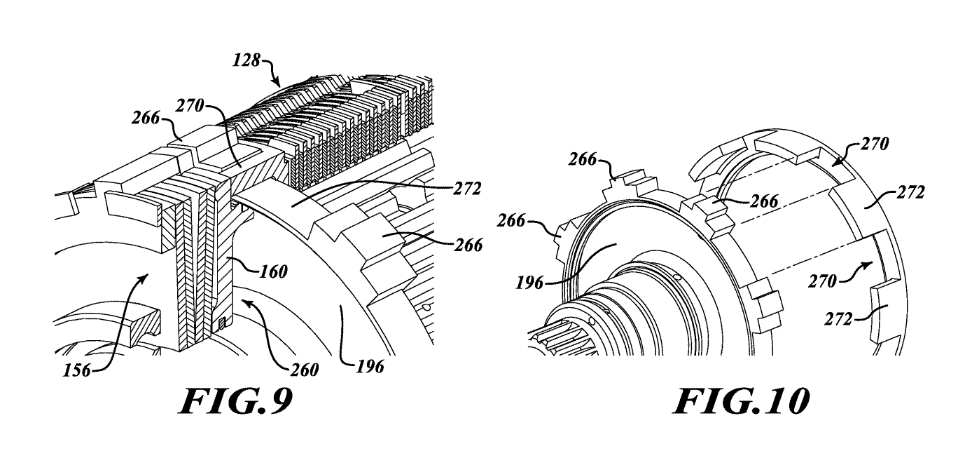

With particular reference now to FIGS. 9 and 10, additional features of the center piston 160 and center clutch spring 156 will be described. A fluid chamber 260 can be defined between the center piston 160 and the central hub 196. As identified above, when fluid is delivered between the central hub 196 and the center piston 160, the center piston 160 is urged against the bias of the center clutch spring 156 to decompress the first clutch 118. The central hub 196 includes a series of lugs 266 arranged therearound. The lugs 266 are received in complementary grooves or openings 270 defined around a ring 272. The lugs 266 are further received in complementary grooves 278 (FIG. 4) defined around an inner diameter of the differential housing 114. The ring 272 reacts against the clutch pack 128. Further, the interaction of the lugs 266 with the grooves 278 on the differential housing 114 rotatably fixes the central hub 196 to the differential housing 114 while still permitting axial translation of the ring 272 relative to the central hub 196 and therefore toward and away from the clutch pack 128.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A torque vectoring differential comprising:
a differential carrier rotatable about an axis;
a pinion carrier having at least one pinion gear mounted for rotation on at least a portion of the pinion carrier, first and second side gears meshed for engagement with the at least one pinion gear, the first side gear engaged for rotation with a first axle shaft, the second side gear engaged for rotation with a second axle shaft;
a first clutch operable to selectively lock the differential carrier and the pinion carrier with respect to one another for rotation about the axis;
a second clutch operable to selectively modulate the differential carrier to the first side gear; and
a third clutch operable to selectively modulate the differential carrier to the second side gear.

2. The torque vectoring differential of claim 1 wherein the torque vectoring differential is selectively and alternatively operable in the following modes:
an open mode wherein the first clutch is locked and the second and third clutches are disengaged;
a torque vectoring mode wherein the first clutch is disengaged and the second and third clutches are modulated between fully locked and fully open positions;
a limited slip mode wherein the first clutch is engaged, at least one of the second and third clutch is modulated between fully locked and fully open positions; and
a locking mode wherein the first clutch is locked and at least one of the second and third clutches are locked.

3. The torque vectoring differential of claim 1 wherein the first clutch is positioned within the differential carrier and is radially outward of the pinion carrier with respect to the axis and wherein the pinion carrier further comprises:
a case defining a cavity; and
a shaft extending across the cavity, wherein the one or more pinion gears are mounted on the shaft and wherein the first clutch engages the case.

4. The torque vectoring differential of claim 1 wherein the differential carrier further comprises:
a primary housing defining first and second chambers, wherein the pinion carrier and the first clutch are positioned in the first chamber; and
a secondary housing defining a third chamber, wherein the primary and secondary housings are releasably coupled together.

5. The torque vectoring differential of claim 4 further comprising:
a first end cap releasably engageable with the primary housing to selectively close the second chamber; and
a second end cap releasably engageable with the secondary housing to selectively close the third chamber.

6. The torque vectoring differential of claim 4 wherein the differential carrier further comprises:
a central hub positioned between the primary housing and the secondary housing along the axis.

7. The torque vectoring differential of claim 6 further comprising:
a fluid pathway extending through the central hub, the fluid pathway operable to direct fluid to the first clutch.

8. The torque vectoring differential of claim 7 wherein the central hub includes a series of lugs arranged therearound, the series of lugs received in complementary openings defined around a ring that acts against the first clutch, wherein the lugs are received in complementary grooves defined around an inner diameter of the primary housing.

9. The torque vectoring differential of claim 8, further comprising:
a center clutch spring that normally biases a center piston to compress the first clutch.

10. The torque vectoring differential of claim 9 wherein the center clutch spring comprises at least one Belleville washer.

11. The torque vectoring differential of claim 1 wherein the differential carrier further comprises:
first and second chambers, wherein the first clutch is positioned in the first chamber and the second clutch is positioned in the second chamber.

12. The torque vectoring differential of claim 11 wherein the differential carrier further comprises:
a primary housing that includes a wall that separates the first and second chambers, wherein the pinion carrier and the first clutch are positioned in the first chamber and the second clutch is positioned in the second chamber; and
a secondary housing defining a third chamber, the primary and secondary housings releasably coupled together, wherein the third clutch is positioned in the third chamber.

13. The torque vectoring differential of claim 1 wherein at least one of the first, second and third clutches is a dog clutch.

14. The torque vectoring differential of claim 1 wherein the torque vectoring differential is lubricated by automatic transmission fluid shared with a transmission and configured to enter the differential carrier through a journal bearing.

15. The torque vectoring differential of claim 14, further comprising a helical groove pump that pumps the automatic transmission fluid through the torque vectoring differential.

16. A torque vectoring differential that outputs torque to a first and a second drive axle, the torque vectoring differential comprising:
a planetary gear set that provides a final drive gear ratio from a transmission;
a differential assembly; and
a torque vectoring assembly comprising:
a first gear set that provides an output from the torque vectoring assembly to the first drive axle;
a second gear set independently interfaced with a first clutch, the second gear set selectively providing torque in a driving direction to the first drive axle; and
a third gear set independently interfaced with a second clutch, the third gear set selectively providing torque in a retarding direction to the first drive axle.

17. The torque vectoring differential of claim 16 wherein the first, second and third gear sets all provide unique gear ratios.

18. The torque vectoring differential of claim 17 wherein when the second gear set is selected, the first drive axle rotates around 20% faster than the second drive axle.

19. The torque vectoring differential of claim 18 wherein when the third gear set is selected, the first drive axle rotates around 20% slower than the second drive axle.

20. The torque vectoring differential of claim 19 wherein in the forward driving direction, torque is alternatively applied in the driving direction as driving torque and in the coasting direction as retarding torque.
